(19) United States
(12) Patent Application Publication
(10) Pub. No.: US 2022/0402497 A1
(43) Pub. Date: Dec. 22, 2022

(54) SYSTEM AND METHOD FOR CONTROLLING VEHICLE ATTITUDE

(71) Applicant: Ford Global Technologies, LLC, Dearborn, MI (US)

(72) Inventors: Keith Weston, Canton, MI (US); Brendan Diamond, Grosse Pointe, MI (US); Michael Alan McNees, Flat Rock, MI (US); Ryan Orourke, Dearborn, MI (US); Matthew Johnson, Toledo, OH (US)

(21) Appl. No.: 17/304,510

(22) Filed: Jun. 22, 2021

(51) Int. Cl. B60W 40/06; B60W 30/18; B60W 10/184; B60W 10/08

(52) U.S. Cl. CPC B60W 40/06; B60W 30/18009; B60W 10/184; B60W 10/08; B60W 2710/083; B60W 2552/20; B60W 2420/52; B60W 2552/35

(57) ABSTRACT

Methods and system are described for adjusting an attitude of an airborne vehicle according to terrain where the vehicle is expected to land. In one example, torque output of an electric machine is adjusted to change a pitch of a vehicle to conform to a pitch of terrain where the vehicle is expected to land so that vehicle stability may be improved.

### FIELD

The present description relates generally to methods and systems for controlling attitude of a vehicle that is airborne. The vehicle may be an electric vehicle, hybrid vehicle, or a vehicle that is propelled solely via an internal combustion engine.

### BACKGROUND/SUMMARY

A vehicle may be purposefully driven off road and jumped via a ramp or features of the ground such that the vehicle becomes airborne. Before the vehicle is jumped, the vehicle's operator may observe features surrounding the area where the vehicle will be jumped so that the operator may know what to expect when jumping the vehicle. On the other hand, there may be times when the vehicle's operator has not surveyed the area where the vehicle will be jumped, or alternatively, there may be a substantial time interval between when the vehicle operator last observed the area surrounding where the vehicle jumps and the time at which the vehicle is jumped. For example, the vehicle may be participating in an off-road race where the terrain varies and vehicle speeds are high enough to cause the vehicle to go airborne. Knowing characteristics of terrain where a vehicle may become airborne (e.g., moving through the air such that the vehicle is not in contact with earth) may allow a vehicle's operator to point the vehicle in a direction where conditions are more suitable for landing a vehicle, but the vehicle's attitude (e.g., orientation with respect to the earth) may make landing the vehicle more or less difficult irrespective of if the vehicle's operator knows conditions of terrain that surrounds the vehicle.

The inventors herein have recognized the above-mentioned issues and have developed a method for operating a vehicle, comprising: adjusting torque applied to one or more wheels of the vehicle while the vehicle is airborne via a controller in response to features of terrain where the vehicle is expected to land.

By adjusting a torque applied to one or more wheels, it may be possible to provide the technical result of adjusting an attitude of a vehicle in response to terrain (e.g., physical features of an area of land) where the vehicle is expected to land after the vehicle returns to earth. In one example, the pitch or roll angles of the vehicle may be adjusted so that the vehicle may land within a predetermined angular range of being parallel to the earth where the vehicle lands (e.g., the location where the vehicle first contacts the earth after being airborne). Consequently, the vehicle's impact energy may be more evenly distributed between the vehicle's four wheels. As a result, there may be a reduced tendency for the vehicle's front end or rear end to impact the earth.

The present description may provide several advantages. In particular, the approach may improve stability of vehicles that become airborne from time to time. In addition, the approach may be useful when a vehicle becomes partially airborne. Further, the approach may improve vehicle performance during off road conditions.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic diagram of a vehicle driveline is shown;

FIGS. 2A-4 show several different views of an airborne vehicle;

FIG. 5 is an example vehicle operating sequence according to the method of FIGS. 6 and 7; and

FIGS. 6 and 7 show an example of a method for operating a vehicle that may go airborne from time to time.

### DETAILED DESCRIPTION

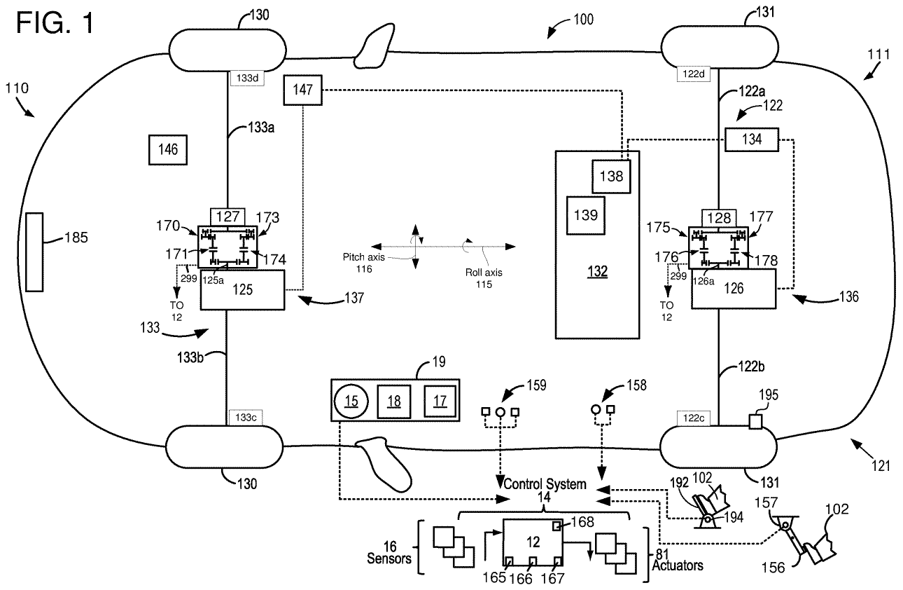

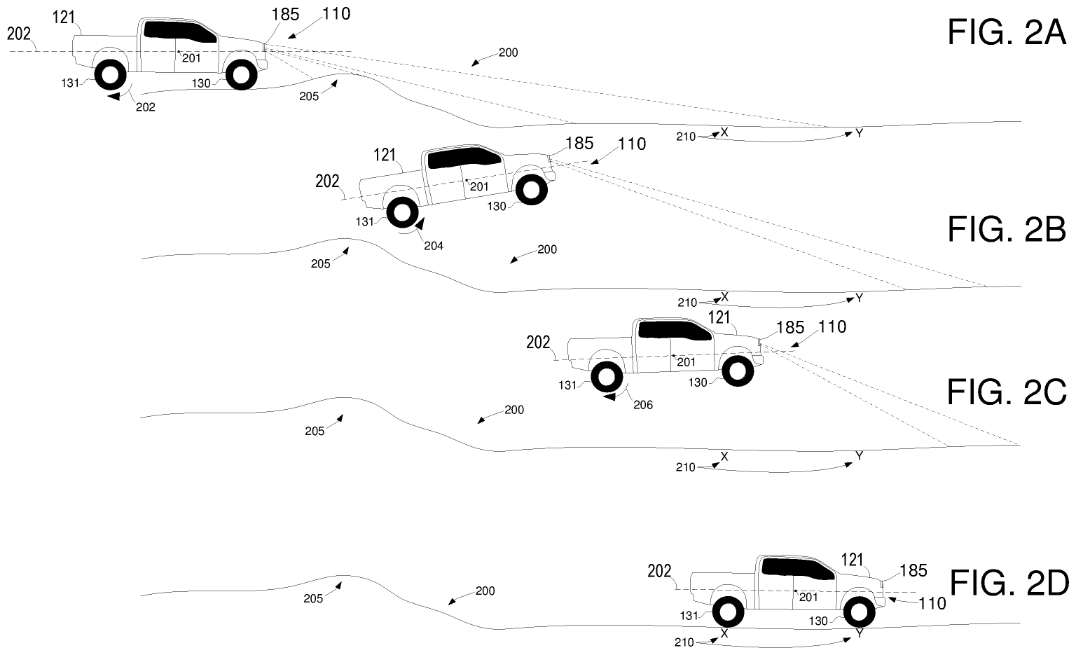

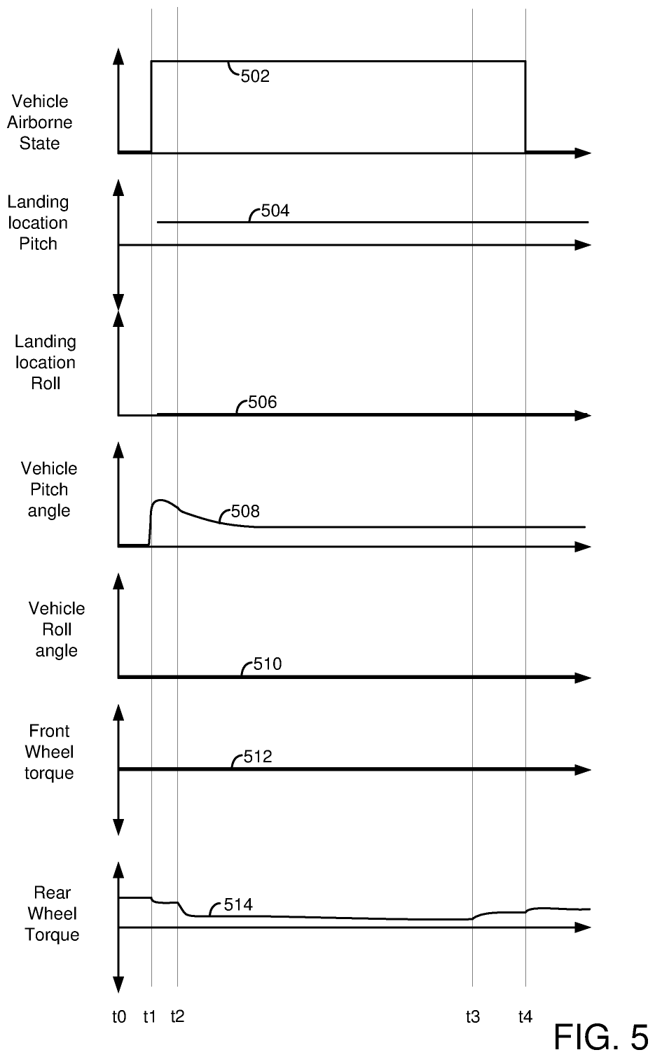

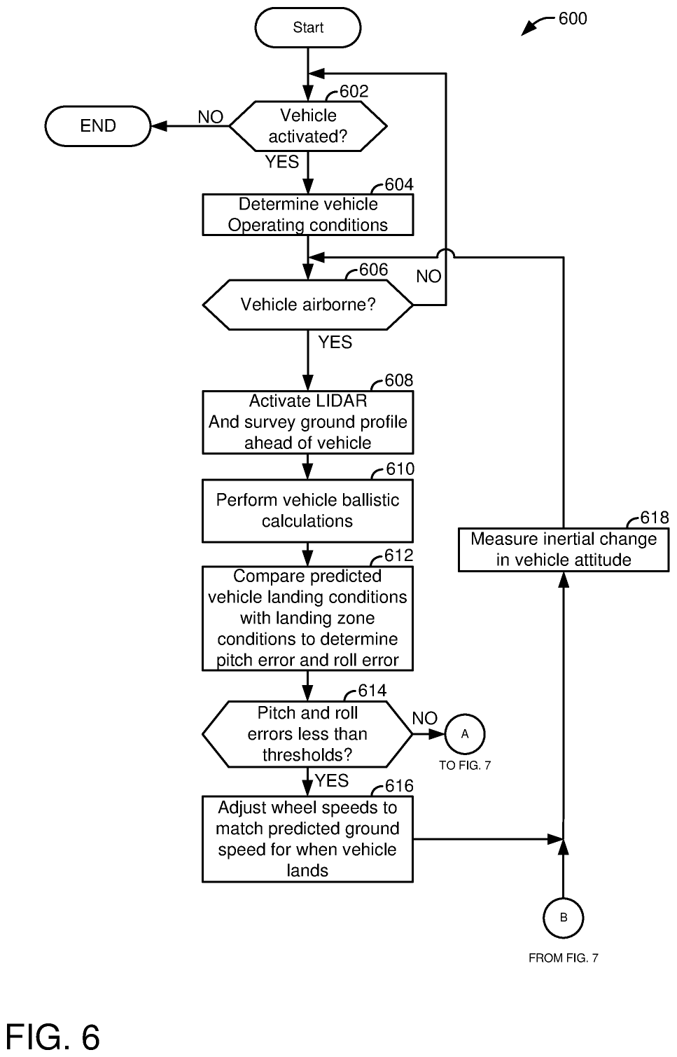

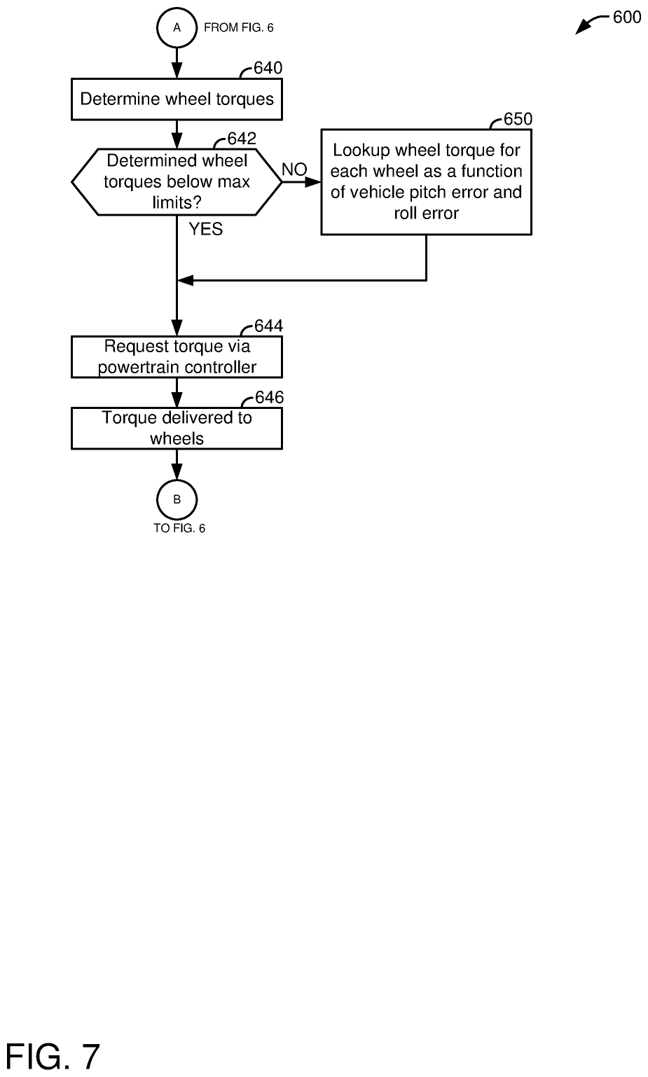

The following description relates to systems and methods for operating a driveline or powertrain of a vehicle to improve vehicle stability when the vehicle goes airborne. The vehicle may include two or more drive wheels drive vehicle that may be configured as an electric vehicle, or alternatively, the vehicle may be configured as a hybrid vehicle or as a conventional vehicle. The methods described herein may also be applied to tracked vehicles. An example vehicle and driveline or powertrain is shown in FIG. 1. FIGS. 2A-4 show an example vehicle jumping. FIG. 5 shows an example driveline operating sequences according to the method of FIGS. 6 and 7. A method for operating an airborne or partially airborne vehicle is shown in FIGS. 6 and 7.

FIG. 1 illustrates an example vehicle propulsion system 100 for vehicle 121. A front portion of vehicle 121 is indicated at 110 and a rear portion of vehicle 121 is indicated at 111. In this example, vehicle propulsion system 100 includes at two propulsion sources including front electric machine 125 and rear electric machine 126. However, in other examples, vehicle 121 may include an electric machine and an internal combustion engine as propulsion sources. Additionally, vehicle 121 may include only an internal combustion engine in some examples. Electric machines 125 and 126 may consume or generate electrical power depending on their operating mode. Throughout the description of FIG. 1, mechanical connections between various components are illustrated as solid lines, whereas electrical connections between various components are illustrated as dashed lines. The vehicle's pitch axis is indicated at 116 and the vehicle's roll axis is indicated at 115.

Vehicle propulsion system 100 has a front axle 133 and a rear axle 122. In some examples, rear axle may comprise two half shafts, for example first half shaft 122a, and second half shaft 122b. Likewise, front axle 133 may comprise a first half shaft 133a and a second half shaft 133b. Vehicle propulsion system 100 further has front wheels 130 and rear wheels 131. In this example, front wheels 130 may be selectively driven via electric machine 125. Rear wheels 131 may be driven via electric machine 126. Friction brakes 133c, 133d, 122c, 122d may provide a braking force to front wheels 130 and rear wheels 131. In alternative examples, vehicle 121 may include four electric machines that provide propulsive effort to vehicle 121, one electric machine per wheel.

The rear axle 122 is coupled to electric machine 126. Rear drive unit 136 may transfer power from electric machine 126 to axle 122 resulting in rotation of drive wheels 131. Rear drive unit 136 may include a low gear set 175 and a high gear 177 that are coupled to electric machine 126 via output shaft 126a of rear electric machine 126. Low gear 175 may be engaged via fully closing low gear clutch 176. High gear 177 may be engaged via fully closing high gear clutch 178. High gear clutch 177 and low gear clutch 178 may be opened and closed via commands received by rear drive unit 136 over CAN 299. Alternatively, high gear clutch 177 and low gear clutch 178 may be opened and closed via digital outputs or pulse widths provided via control system 14. Rear drive unit 136 may include differential 128 so that torque may be provided to axle 122a and to axle 122b. In some examples, an electrically controlled differential clutch (not shown) may be included in rear drive unit 136.

The front axle 133 is coupled to electric machine 125. Front drive unit 137 may transfer power from electric machine 125 to axle 133 resulting in rotation of drive wheels 130. Front drive unit 137 may include a low gear set 170 and a high gear 173 that are coupled to electric machine 125 via output shaft 125a of front electric machine 125. Low gear 170 may be engaged via fully closing low gear clutch 171. High gear 173 may be engaged via fully closing high gear clutch 174. High gear clutch 174 and low gear clutch 171 may be opened and closed via commands received by front drive unit 137 over CAN 299. Alternatively, high gear clutch 174 and low gear clutch 171 may be opened and closed via digital outputs or pulse widths provided via control system 14. Front drive unit 137 may include differential 127 so that torque may be provided to axle 133a and to axle 133b. In some examples, an electrically controlled differential clutch (not shown) may be included in front drive unit 137.

Electric machines 125 and 126 may receive electrical power from onboard electrical energy storage device 132. Furthermore, electric machines 125 and 126 may provide a generator function to convert the vehicle's kinetic energy into electrical energy, where the electrical energy may be stored at electric energy storage device 132 for later use by the electric machine 125 and/or electric machine 126. A first inverter system controller (ISC1) 134 may convert alternating current generated by rear electric machine 126 to direct current for storage at the electric energy storage device 132 and vice versa. A second inverter system controller (ISC2) 147 may convert alternating current generated by front electric machine 125 to direct current for storage at the electric energy storage device 132 and vice versa. Electric energy storage device 132 may be a battery, capacitor, inductor, or other electric energy storage device.

In some examples, electric energy storage device 132 may be configured to store electrical energy that may be supplied to other electrical loads residing on-board the vehicle (other than the motor), including cabin heating and air conditioning, engine starting, headlights, cabin audio and video systems, etc.

Control system 14 may communicate with one or more of electric machine 125, electric machine 126, energy storage device 132, etc. Control system 14 may receive sensory feedback information from one or more of electric machine 125, electric machine 126, energy storage device 132, etc. Further, control system 14 may send control signals to one or more of electric machine 125, electric machine 126, energy storage device 132, etc., responsive to this sensory feedback. Control system 14 may receive an indication of an operator requested output of the vehicle propulsion system from a human operator 102, or an autonomous controller. For example, control system 14 may receive sensory feedback from pedal position sensor 194 which communicates with pedal 192. Pedal 192 may refer schematically to a driver demand pedal. Similarly, control system 14 may receive an indication of an operator requested vehicle braking via a human operator 102, or an autonomous controller. For example, control system 14 may receive sensory feedback from pedal position sensor 157 which communicates with brake pedal 156.

Energy storage device 132 may periodically receive electrical energy from a power source such as a stationary power grid (not shown) residing external to the vehicle (e.g., not part of the vehicle). As a non-limiting example, vehicle propulsion system 100 may be configured as a plug-in electric vehicle (EV), whereby electrical energy may be supplied to energy storage device 132 via the power grid (not shown).

Electric energy storage device 132 includes an electric energy storage device controller 139 and a power distribution module 138. Electric energy storage device controller 139 may provide charge balancing between energy storage element (e.g., battery cells) and communication with other vehicle controllers (e.g., controller 12). Power distribution module 138 controls flow of power into and out of electric energy storage device 132.

One or more wheel speed sensors (WSS) 195 may be coupled to one or more wheels of vehicle propulsion system 100. The wheel speed sensors may detect rotational speed of each wheel. Such an example of a WSS may include a permanent magnet type of sensor. Vehicle 121 may also include a light detection and ranging sensor 185 to determine features of terrain and objects that are in front of vehicle 121. Alternatively, ranging sensor 185 may be a RADAR or other known ranging sensor.

Vehicle propulsion system 100 may further include a motor electronics coolant pump (MECP) 146. MECP 146 may be used to circulate coolant to diffuse heat generated by at least electric machine 120 of vehicle propulsion system 100, and the electronics system. MECP may receive electrical power from onboard energy storage device 132, as an example.

Controller 12 may comprise a portion of a control system 14. In some examples, controller 12 may be a single controller of the vehicle. Control system 14 is shown receiving information from a plurality of sensors 16 (various examples of which are described herein) and sending control signals to a plurality of actuators 81 (various examples of which are described herein). As one example, sensors 16 may include tire pressure sensor(s) (not shown), wheel speed sensor(s) 195, light detection and ranging sensor 185, suspension height sensors 158, pitch, yaw, and roll angle sensors 159 (e.g., inertial sensors), etc. In some examples, sensors associated with electric machine 125, electric machine 126, wheel speed sensor 195, etc., may communicate information to controller 12, regarding various states of electric machine operation. Controller 12 includes non-transitory (e.g., read only memory) 165, random access memory 166, digital inputs/outputs 168, and a microcontroller 167.

Vehicle propulsion system 100 may also include an on-board navigation system 17 (for example, a Global Positioning System) on dashboard 19 that an operator of the vehicle may interact with. The navigation system 17 may include one or more location sensors for assisting in estimating a location (e.g., geographical coordinates) of the vehicle. For example, on-board navigation system 17 may receive signals from GPS satellites (not shown), and from the signal identify the geographical location of the vehicle. In some examples, the geographical location coordinates may be communicated to controller 12.

Dashboard 19 may further include a display system 18 configured to display information to the vehicle operator. Display system 18 may comprise, as a non-limiting example, a touchscreen, or human machine interface (HMI), display which enables the vehicle operator to view graphical information as well as input commands. In some examples, display system 18 may be connected wirelessly to the internet (not shown) via controller (e.g. 12). As such, in some examples, the vehicle operator may communicate via display system 18 with an internet site or software application (app).

Dashboard 19 may further include an operator interface 15 via which the vehicle operator may adjust the operating status of the vehicle. Specifically, the operator interface 15 may be configured to initiate and/or terminate operation of the vehicle driveline (e.g., electric machine 125 and electric machine 126) based on an operator input. Various examples of the operator ignition interface 15 may include interfaces that require a physical apparatus, such as an active key, that may be inserted into the operator interface 15 to start the electric machines 125 and 126 and to turn on the vehicle, or may be removed to shut down the electric machines 125 and 126 to turn off the vehicle. Other examples may include a passive key that is communicatively coupled to the operator interface 15. The passive key may be configured as an electronic key fob or a smart key that does not have to be inserted or removed from the interface 15 to operate the vehicle electric machines 125 and 126. Rather, the passive key may need to be located inside or proximate to the vehicle (e.g., within a threshold distance of the vehicle). Still other examples may additionally or optionally use a start/stop button that is manually pressed by the operator to start or shut down the electric machines 125 and 126 to turn the vehicle on or off. In other examples, a remote electric machine start may be initiated remote computing device (not shown), for example a cellular telephone, or smartphone-based system where a user's cellular telephone sends data to a server and the server communicates with the vehicle controller 12 to start the engine.

The system of FIG. 1 provides for a vehicle system, comprising: an electric machine coupled to a wheel of a vehicle; a terrain sensing device; a controller including executable instructions stored in non-transitory memory to adjust a torque of the electric machine when the vehicle is airborne in response to output of the terrain sensing device. The vehicle system includes where adjusting the torque of the electric machine includes increasing the torque of the electric machine. The vehicle system includes where adjusting the torque of the electric machine includes decreasing the torque of the electric machine. The vehicle system includes where the terrain sensing device is a light detecting and ranging device (LIDAR). The vehicle system further comprises additional instructions to adjust a pitch of the vehicle via adjusting torque of the electric machine. The vehicle system further comprises additional instructions to adjust roll of the vehicle via adjusting torque of the electric machine. The vehicle system further comprises adjusting a torque of a second electric machine when the vehicle is airborne in response to output of the terrain sensing device. The vehicle system includes where the electric machine is coupled to a rear axle of the vehicle, and where the second electric machine is coupled to front axle of the vehicle.

Referring now to FIGS. 2A-2D, an example vehicle jump is shown. In particular, FIG. 2A shows a vehicle in a pre-launch position, FIG. 2B shows the vehicle early in an airborne phase, FIG. 2C shows the vehicle late in the airborne phase, and FIG. 2D shows the vehicle landed. The vehicle may operate according to the method of FIGS. 6 and 7 during the jump.

Vehicle 121 is shown approaching bump 205 in terrain 200 in FIG. 2A. The ranging sensor 185 is scanning terrain 200 in front of vehicle 121 to determine changes in grade or angle of terrain 200 relative to longitudinal axis 202 and lateral axis 201 of vehicle 121. Rear wheels 131 are rotating in a direction indicated by arrow 202. Front wheels 130 rotate in a same direction. The predicted landing location for vehicle 121 is indicated at 210 via an X for the rear wheels and a Y for front wheels.

Vehicle 121 has cleared bump 205 and it is airborne in FIG. 2B. Front of vehicle 110 is shown pitched up. A vehicle controller estimates the landing location 210 of vehicle 121 and it estimates a pitch angle of vehicle 121 according to the vehicle's longitudinal axis 202 and a plane of the predicted landing location 210. As described herein, the pitch angle while a vehicle is airborne is an angle between a longitudinal axis of the vehicle and a plane describing the landing location. The plane describing the landing location may be a plane that extends from a predicted right front wheel landing location, to a predicted left front wheel landing location, to a predicted left rear wheel landing location, and to a predicted right rear wheel landing location. The predicted landing location 210 may be at a flat, have a positive grade or angle, or have a negative grade or angle. The landing location 210 may be flat if one location on a plane describing the landing location is equal in elevation as another location on the plane describing the landing location. The landing location 210 may be on a positive or negative grade or angle if one location on the plane describing the landing location is higher or lower in elevation than another location on the plane describing the landing location.

In the example of FIGS. 2A-2D, the grade or angle of the predicted landing zone is zero (e.g., flat), but the pitch angle of vehicle 121 is large enough that rear wheels 131 may be expected to land substantially earlier than front wheels 130 if corrective action is not taken. If rear wheels 131 land significantly before front wheels 130, a rear suspension (not shown) of vehicle 121 may be subjected to higher loads than may be desired. Similarly, if front wheels 130 land significantly before rear wheels 131, a front suspension (not shown) of vehicle 121 may be subjected to higher loads than may be desired. Therefore, it may be desirable for front wheels 130 to land at nearly the same time as rear wheels 131 so that the front and rear vehicle suspensions may more equally share the vehicle load when the vehicle lands. For example, it may be desirable for the front wheels to reach ground before a rear suspension of the vehicle is fully compressed after the rear wheels have landed. Likewise, it may be desirable for the rear wheels to reach ground before a front suspension of the vehicle is fully compressed after the front wheels have landed. A controller in vehicle 121 applies a torque as indicated at 204 to slow the rotation of rear wheels 131, which may cause front end 110 to lower, thereby improving a possibility of the front wheels landing (reaching the ground) before the rear suspension fully compresses. The torque that is indicated at 204 may slow wheel rotation and the torque may be provided via vehicle friction brakes (e.g., 122c, 122d, 133c, 133d) or via an electric machine (e.g., 126).

Vehicle 121 is still airborne and it is nearing predicted landing location 210 in FIG. 2C. The front 110 of vehicle 121 has been rotated down such that longitudinal axis 202 of vehicle 121 is nearly parallel with landing location 210 (e.g., the pitch angle of vehicle 121 is nearly zero). The controller may also adjust wheel speed such that wheel speed matches an estimated speed of vehicle 121 when vehicle 121 lands at location 210. For example, if vehicle speed is 100 kilometers/hour, then the rotational speeds of the wheels are adjusted so that the rotational speeds of the wheels is equivalent to 100 kilometers/hour. In this example, torque is added to the wheel such that wheel speed increases in direction 206. By matching wheel speed with estimated vehicle speed at the time of vehicle landing, it may be possible to reduce wheel slip experienced during landing of vehicle 121.

Vehicle 121 is shown landing at the predicted landing location 210. The longitudinal axis 202 is parallel with the grade or angle of terrain 200 when vehicle 121 lands (e.g., is no longer airborne).

Thus, a longitudinal axis of the vehicle may rotate while a vehicle is airborne so that the longitudinal axis of the vehicle is nearly parallel with the ground when a vehicle lands so that vehicle load may be more evenly distributed over four wheels, thereby reducing a possibility of vehicle suspension degradation. Additionally, a lateral axis of the vehicle may rotate while a vehicle is airborne so that the lateral axis of the vehicle is nearly parallel with the ground when a vehicle lands so that vehicle load may be more evenly distributed over four wheels, thereby reducing a possibility of vehicle suspension degradation.

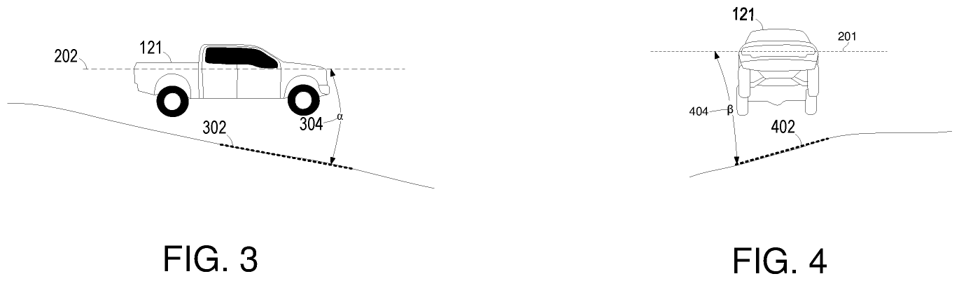

Referring now to FIG. 3, a pitch angle a for vehicle 121 is shown. Vehicle 121 is airborne and level (e.g., the front end of the vehicle is at a same elevation as the rear end of the vehicle), but vehicle 121 is not parallel with a plane that describes the landing location 302 because the plane that describes the landing location is oriented at a grade or angle. The pitch angle a is indicated at 304 as being between a plane describing the landing location 302 and longitudinal axis 202 of vehicle 121. The attitude of vehicle 121 may be adjusted via applying positive torques (torques that accelerate a wheel according to the wheel's present rotational direction) or negative torques (torques that decelerate a wheel according to the wheel's present rotational direction) to one or more vehicle wheels so that the angle may be relatively small (e.g., less than 5 degrees) so as to distribute the load of the vehicle across the vehicle's four wheels when the vehicle lands.

Referring now to FIG. 4, a roll angle β for vehicle 121 is shown. Vehicle 121 is airborne and level with respect to a lateral axis 402 (e.g., the right side of the vehicle is at a same elevation as the left side of the vehicle), but vehicle 121 is not parallel with a plane that describes the landing location 402 because the plane that describes the landing location is oriented at a grade or angle. The roll angle β is indicated at 404 as being between a plane describing the landing location 402 and lateral axis 201 of vehicle 121. The attitude of vehicle 121 may be adjusted via applying positive torques (torques that accelerate a wheel according to the wheel's present rotational direction) or negative torques (torques that decelerate a wheel according to the wheel's present rotational direction) to one or more vehicle wheels so that the angle β may be relatively small (e.g., less than 5 degrees) so as to distribute the load of the vehicle across the vehicle's four wheels when the vehicle lands.

Referring now to FIG. 5, a prophetic vehicle operating sequence according to the method of FIGS. 6 and 7 is shown. The sequence of FIG. 5 may be provided via the system of FIG. 1 in cooperation with the method of FIGS. 6 and 7. The vertical lines at times t0-t4 indicate times of interest during the sequence.

The first plot from the top of FIG. 5 is a plot of vehicle airborne state versus time. The vertical axis represents the vehicle airborne state and the vehicle is airborne when trace 502 is at a higher level near the vertical axis arrow. The vehicle is not airborne when trace 502 is at a lower level near the horizontal axis. The horizontal axis represents time and time increases from the left side of the figure to the right side of the figure. Trace 502 represents the vehicle airborne state.

The second plot from the top of FIG. 5 is a plot of vehicle landing location longitudinal grade or angle versus time. The vertical axis represents the vehicle landing location longitudinal grade or angle and the vehicle landing location longitudinal grade or angle increases in the direction of the vertical axis arrow. The horizontal axis represents time and time increases from the left side of the figure to the right side of the figure. Trace 504 represents the vehicle landing location longitudinal grade or angle.

The third plot from the top of FIG. 5 is a plot of vehicle landing location lateral grade or angle versus time. The vertical axis represents the vehicle landing location lateral grade or angle and the vehicle landing location lateral grade or angle increases in the direction of the vertical axis arrow. The horizontal axis represents time and time increases from the left side of the figure to the right side of the figure. Trace 506 represents the vehicle landing location lateral grade or angle.

The fourth plot from the top of FIG. 5 is a plot of vehicle pitch angle versus time. The vertical axis represents the vehicle pitch angle and the pitch angle increases in the direction of the vertical axis arrow. The horizontal axis represents time and time increases from the left side of the figure to the right side of the figure. Trace 508 represents the vehicle pitch.

The fifth plot from the top of FIG. 5 is a plot of vehicle roll angle versus time. The vertical axis represents the vehicle roll angle and the roll angle increases in the direction of the vertical axis arrow. The horizontal axis represents time and time increases from the left side of the figure to the right side of the figure. Trace 510 represents the vehicle roll.

The sixth plot from the top of FIG. 5 is a plot of front wheel torque versus time. The vertical axis represents front wheel torque and the front wheel torque increases in the direction of the vertical axis arrow. The horizontal axis represents time and time increases from the left side of the figure to the right side of the figure. Trace 512 represents the front wheel torque.

The seventh plot from the top of FIG. 5 is a plot of rear wheel torque versus time. The vertical axis represents rear wheel torque and the rear wheel torque increases in the direction of the vertical axis arrow. The horizontal axis represents time and time increases from the left side of the figure to the right side of the figure. Trace 514 represents the rear wheel torque.

At time t0, the vehicle is traveling on the ground (earth) and scanning the terrain that is ahead of the vehicle (not shown). The vehicle landing location longitudinal grade or angle is unknown because the vehicle is not airborne. Further, the vehicle landing location lateral grade or angle is unknown because the vehicle is not airborne. The vehicle pitch angle is zero and the vehicle roll angle is zero. There is no front wheel torque and the rear wheel torque is at a medium level. Shortly before time t1, the vehicle pitch angle increases as the vehicle engages a bump in the terrain.

At time t1, the vehicle goes airborne and the vehicle pitch angle approaches a peak (maximum) angle. The vehicle roll angle is zero and torque to the rear wheels is reduced to prevent the wheels from accelerating to a higher speed. Front wheel torque is unchanged at zero and shortly after time t1, the longitudinal grade or angle of a predicted vehicle landing location is determined via a data generated by a range sensing device. In addition, a lateral grade or angle of the predicted vehicle landing location is determined via data generated by the range sensing device.

At time t2, the vehicle remains airborne and the rear wheel torque is reduced further to cause the front of the vehicle to rotate downward, thereby reducing the vehicle pitch angle. The vehicle pitch angle is adjusted in response to the landing location longitudinal grade or angle so that the vehicle's longitudinal axis is nearly parallel to the longitudinal grade or angle of the vehicle landing location. The vehicle landing location lateral grade or angle is zero and there is no indication of vehicle roll.

At time t3, the vehicle remains airborne and rear wheel torque is increased a small amount so that vehicle wheel speed will match vehicle speed when the vehicle lands. The landing location longitudinal grade or angle and lateral grade or angle are unchanged. The vehicle pitch angle causes the vehicle's longitudinal axis to be nearly parallel to the longitudinal grade or angle of the vehicle landing location.

At time t4, the vehicle lands and the vehicle pitch angle remains unchanged. The vehicle roll angle is also unchanged. The front wheel torque is unchanged and the rear wheel torque is increased to maintain vehicle speed.

In this way, attitude of a vehicle may be adjusted while a vehicle is airborne in response to a predicted landing location of a vehicle so that vehicle stability may be improved. The vehicle's front may be rotated up or down, within limits, via adjusting wheel torques. The vehicle's attitude from side to side may also be adjusted via adjusting torques applied to left and right wheels.

Referring now to FIGS. 6 and 7, an example method for operating a vehicle that goes airborne from time to time is shown. The method of FIGS. 6 and 7 may be incorporated into and may cooperate with the system of FIG. 1. Further, at least portions of the method of FIGS. 6 and 7 may be incorporated as executable instructions stored in non-transitory memory while other portions of the method may be performed via a controller transforming operating states of devices and actuators in the physical world.

At 602, method 600 judges if the vehicle is activated. Method may judge that the vehicle is activated if one or more of the vehicle's propulsion sources are supplied with electric power. Alternatively, method 600 may judge that the vehicle is activated if the vehicle includes an internal combustion engine and the internal combustion engine is combusting fuel. If method 600 judges that the vehicle is activated, the answer is yes and method 600 proceeds to 604. Otherwise, the answer is no and method 600 proceeds to exit.

At 604, method 600 determines vehicle operating conditions. Vehicle operating conditions may include but are not limited to vehicle speed, driver demand torque, vehicle pitch angle, vehicle roll angle, operating states of axle clutches, present wheel torque, and brake pedal position. Method 600 proceeds to 606.

At 606, method 600 judges whether or not the vehicle is airborne. The vehicle may be fully airborne with all four wheels off the ground, or alternatively, the vehicle may have a front or rear axle that is off the ground and airborne. In one example, method 600 may judge that the vehicle is airborne when vehicle suspension sensors indicate that the vehicle's suspension components are fully extended. If method 600 judges that the vehicle is airborne, the answer is yes and method 600 returns to 608. Otherwise, the answer is no and method 600 returns to 602.

At 608, method 600 activates a ranging device (e.g., LIDAR, RADAR, etc.) that detects features (e.g., grade or angles, hill, depression, cliff, etc.) of terrain that the vehicle is approaching. The ranging device may supply a vehicle controller with data regarding a survey of the terrain in the vehicle's path. For example, the ranging device may send the vehicle controller longitudinal grade or angle and lateral grade or angle measurements to the vehicle controller so that the vehicle controller may make adjustments to wheel torque. In addition, the ranging device may also determine positions of objects in the vicinity of the vehicle. Method 600 proceeds to 610.

At 610, method 600 performs ballistic calculations to determine a predicted landing location and amount of time the vehicle is in flight or airborne. In one example, method 600 solves the following equations to determine the vehicle's predicted landing location and time in flight:

$$X = V0 \cdot tin fl \cdot cos ( θ )$$

$$Z = V0 \cdot tin fl \cdot sin ( θ ) - \frac{( g \cdot tin {fl}^{2} )}{2}$$

where X is the horizontal displacement of the vehicle, Z is the vertical displacement of the vehicle, V0 is the velocity of the vehicle when it initially leaves the ground, tinfl is the amount of time since the vehicle has left the ground, ⊖ is the angle between the vehicle trajectory and the horizontal plane (earth), and g is the acceleration of gravity constant. V0 may be assumed to be equal to the vehicle reference speed when the vehicle leaves the ground. LIDAR data may provide the estimate of vertical speed Vz, which allows e to be solved via the following equation:

$$θ = arc sin ( \frac{( V z - g \cdot tin fl )}{V 0} )$$

The path that the vehicle will follow and where the path will intersect data from a LIDAR point cloud (e.g., data that represents the geographical environment in front of the vehicle) indicates the vehicle landing zone. The time in flight estimate may be determined from the landing zone estimate. Method 600 proceeds to 612.

At 612, method 600 compares the vehicle's present roll angle and pitch angle with the longitudinal grade or angle of the predicted vehicle landing position and the lateral grade or angle of the predicted vehicle landing position. In one example, method 600 determines a pitch error and a roll error via the following equations:

Pitcherr=(tinfl·prate)−(vpit−lzloggrade)

Rollerr=(tinfl·rrate)−(vroll−lzlatgrade)

where Pitcherr is the pitch angular error between the vehicle and the vehicle landing location, tinfl is the amount of time that the vehicle is predicted to be in flight, prate is the pitch rate of change, vpit is the present vehicle pitch angle, lzloggrade is the longitudinal grade of the predicted landing location, Rollerr is the roll angular error between the vehicle and the vehicle landing location, rrate is the roll rate of change, vroll is the present vehicle roll angle, and lzlatgrade is the lateral grade of the predicted landing location. Method 600 proceeds to 614.

At 614, method 600 judges if the vehicle pitch angle error is less than a first threshold and if the vehicle roll angle error is less than a second threshold. If so, the answer is yes and method 600 proceeds to 614. Otherwise, the answer is no and method 600 proceeds to 640. Step 614 determines whether or not adjustments in pitch and roll angles of the vehicle are to be made via changing wheel torques. If pitch and roll adjustments are needed so that the vehicle lands parallel to the ground, method 600 proceeds to 640.

At 616, method 600 adjusts the wheel speeds of wheels that are coupled to a propulsion source (e.g., electric machine or internal combustion engine) to match vehicle speed at the predicted vehicle landing location. Thus, if the vehicle speed is predicted to be 100 kilometers/hour, the rotational speed of the wheels is adjusted to rotate at a speed that corresponds to a speed at which the wheels rotate when the vehicle is traveling 100 kilometers/hour while the wheels are not slipping relative to the road or earth. By matching rotational speeds of wheels to the vehicle speed, vehicle stability may be improved when the vehicle lands because less wheel slip may be generated when the vehicle lands. Method 600 proceeds to 618.

At 618, method 600 measures inertial changes in the vehicle's attitude. In one example, method 600 determines the vehicle's pitch angle and roll angle from output of inertial sensors. Method 600 returns to 606.

At 640, method 600 determines wheel torques to reduce the roll and pitch angle errors. In one example, the roll angle error, pitch angle error, and vehicle speed reference a table or function of empirically determined wheel torque values for each of the vehicle's wheels. The table or function outputs a positive torque (e.g., accelerate the wheel's rotational speed) or a negative torque (e.g., slow the wheel's rotational speed) that may reduce the roll angle error and the pitch angle error. The values in the table may be empirically determined via suspending the vehicle in air and making adjustments to individual wheel torques while measuring the effects of the torques on pitch angle and roll angle. Method 600 proceeds to 642.

At 642, method 600 judges if the determined wheel torques are below maximum limits for each of the vehicle's wheels. If so, the answer is yes and method 600 proceeds to 644. Otherwise, the answer is no and method 600 proceeds to 650.

At 644, method 600 requests the torque values determined at 640 or 656. The torques may be requested via electric machines, an internal combustion engine, and/or vehicle friction brakes. For example, if the vehicle includes an electric machine for each axle, the front axle electric machine torque may be increased and the rear axle electric machine torque may be decreased. Alternatively, friction brakes may be applied to front wheels and rear wheels may be accelerated via an electric machine or via an internal combustion engine. In another example, where the vehicle includes an electric machine for each wheel, each of the electric machines may be commanded with a unique torque to adjust the vehicle roll angle or the vehicle pitch angle. Method 600 proceeds to 646.

At 646, method 600 delivers the requested torques. The requested torques may be delivered via the electric machines, friction brakes, and internal combustion engine. Method 600 returns to 618.

At 650, method 600 references lookup tables that output wheel torque adjustments based on the vehicle's characteristics. The tables may be referenced via pitch and roll errors when optimal torques from step 640 are greater than the vehicle or wheel electric machines are capable of. In one example, the torque values that are output from the tables are based on durability limits of the electric machines. Method 600 proceeds to 644.

Thus, method 600 may adjust torque applied to one or more vehicle wheels while a vehicle is airborne in response to output of a ranging device. The ranging device may reveal terrain features (grades, grade or angles, etc.) and the vehicle's pitch and roll angles may be adjusted to promote vehicle stability when the vehicle lands.

The method of FIGS. 6 and 7 provides for a method for operating a vehicle, comprising: adjusting torque applied to one or more wheels of the vehicle while the vehicle is airborne via a controller in response to features of terrain where the vehicle is expected to land (e.g., first contact the ground after being airborne). The method includes where the features of the terrain include a longitudinal grade or angle with respect to a longitudinal axis of the vehicle. The method includes where the features of the terrain include a lateral grade or angle with respect to a lateral axis of the vehicle. The method includes where adjusting torque applied to one or more wheels includes adjusting torque of a front wheel. The method includes where adjusting torque applied to one or more wheels includes adjusting torque of a rear wheel. The method includes where adjusting torque applied to one or more wheels includes applying vehicle brakes. The method includes where adjusting torque applied to one or more wheels includes adjusting torque output of an electric machine.

The method of FIGS. 6 and 7 also provides for A method for operating a vehicle, comprising: sensing features of terrain in front of the vehicle via a range sensing device; and adjusting torque applied to one or more wheels of the vehicle while the vehicle is airborne via a controller in response to output of the range sensing device. The method includes where the features include a longitudinal grade referenced to a longitudinal axis of the vehicle. The method further comprises adjusting a speed of a wheel to match ground speed while the vehicle is airborne after adjusting torque applied to one or more wheels of the vehicle while the vehicle is airborne via the controller in response to output of the range sensing device. The method includes where the features include a lateral grade referenced to a lateral axis of the vehicle. The method further comprises adjusting torque applied to the one or more wheels of the vehicle while the vehicle is airborne via the controller in response to an attitude of the vehicle.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller. One or more of the method steps described herein may be omitted if desired.

It will be appreciated that the configurations and routines disclosed herein are exemplary in nature, and that these specific examples are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for operating a vehicle, comprising:
adjusting torque applied to one or more wheels of the vehicle while the vehicle is airborne via a controller in response to features of terrain where the vehicle is expected to land.

2. The method of claim 1, where the features of the terrain include a longitudinal grade or angle with respect to a longitudinal axis of the vehicle.

3. The method of claim 2, where the features of the terrain include a lateral grade or angle with respect to a lateral axis of the vehicle.

4. The method of claim 1, where adjusting torque applied to one or more wheels includes adjusting torque of a front wheel.

5. The method of claim 1, where adjusting torque applied to one or more wheels includes adjusting torque of a rear wheel.

6. The method of claim 1, where adjusting torque applied to one or more wheels includes applying vehicle brakes.

7. The method of claim 1, where adjusting torque applied to one or more wheels includes adjusting torque output of an electric machine.

8. A vehicle system, comprising:
an electric machine coupled to a wheel of a vehicle;
a terrain sensing device;
a controller including executable instructions stored in non-transitory memory to adjust a torque of the electric machine when the vehicle is airborne in response to output of the terrain sensing device.

9. The vehicle system of claim 8, where adjusting the torque of the electric machine includes increasing the torque of the electric machine.

10. The vehicle system of claim 8, where adjusting the torque of the electric machine includes decreasing the torque of the electric machine.

11. The vehicle system of claim 8, where the terrain sensing device is a light detecting and ranging device (LIDAR).

12. The vehicle system of claim 8, further comprising additional instructions to adjust a pitch of the vehicle via adjusting torque of the electric machine.

13. The vehicle system of claim 8, further comprising additional instructions to adjust roll of the vehicle via adjusting torque of the electric machine.

14. The vehicle system of claim 8, further comprising adjusting a torque of a second electric machine when the vehicle is airborne in response to output of the terrain sensing device.

15. The vehicle system of claim 14, where the electric machine is coupled to a rear axle of the vehicle, and where the second electric machine is coupled to front axle of the vehicle.

16. A method for operating a vehicle, comprising:
sensing features of terrain in front of the vehicle via a range sensing device; and
adjusting torque applied to one or more wheels of the vehicle while the vehicle is airborne via a controller in response to output of the range sensing device.

17. The method of claim 16, where the features include a longitudinal grade referenced to a longitudinal axis of the vehicle.

18. The method of claim 16, further comprising adjusting a speed of a wheel to match ground speed while the vehicle is airborne after adjusting torque applied to one or more wheels of the vehicle while the vehicle is airborne via the controller in response to output of the range sensing device.

19. The method of claim 16, where the features include a lateral grade referenced to a lateral axis of the vehicle.

20. The method of claim 16, further comprising adjusting torque applied to the one or more wheels of the vehicle while the vehicle is airborne via the controller in response to an attitude of the vehicle.
